(19) United States
(12) Patent Application Publication
(10) Pub. No.: US 2009/0056200 A1
(43) Pub. Date: Mar. 5, 2009

(54) Apparatus and Methods for Producing Biodiesel Using an Alkali Ion Donating Catalyst

(76) Inventor: Ashok V. Joshi, Salt Lake City, UT (US)

Correspondence Address: CERAMATEC, INC., 2425 SOUTH 900 WEST, SALT LAKE CITY, UT, 84119, US

(21) Appl. No.: 12/205,729

(22) Filed: Sep. 5, 2008

Related U.S. Application Data
(60) Provisional application No. 60/970,182, filed on Sep. 5, 2007.

(51) Int. Cl. C10L 1/02; B01J 19/00; B01J 19/08

(52) U.S. Cl. 44/302; 422/129; 422/198; 422/186.04; 422/211

(57) ABSTRACT

Methods and apparatus for synthesizing biodiesel using an alkali ion donating material are disclosed. Generally, the methods include placing an alcohol and a triglyceride in a container having the alkali ion donating material. A biodiesel reaction driving force is applied to the contents of the container. This force may cause the ion donating material to release alkali ions that react with the alcohol to form an alkali alcoholate. In turn, the alkali alcoholate reacts with triglycerides to form biodiesel and an alkali salt of glycerine. When the driving force is removed and where the alkali ion donating material comprises a catalyst with a high affinity for alkali ions, the alkali ion in the alkali salt of glycerine returns to the alkali ion donating material. Accordingly, the apparatus and methods may produce substantially pure biodiesel and glycerine.

### CROSS-REFERENCE TO RELATED APPLICATION

This application claims the benefit of U.S. Provisional Patent Application No. 60/970,182, filed Sep. 5, 2007, the entire disclosure of which is incorporated by reference.

### FIELD OF THE INVENTION

The present disclosure relates to the apparatus and methods for the chemical synthesis of biodiesel. Generally, the apparatus and methods use an alkali ion donating material to create an alkali alcoholate that reacts with triglycerides to form biodiesel and glycerine.

### BACKGROUND OF THE INVENTION

Biodiesel is an alternative fuel source to petrodiesel, JP-8, and standard gasoline. Moreover, the use of biodiesel is growing in popularity and market penetration in the United States and worldwide. Current methods of making biodiesel are outlined in the publication Biodiesel Production Technology, NREL, July 2004 (NREL/SR-510-36244). Biodiesel may be defined as a petrodiesel equivalent processed fuel derived from biological sources. Typically, biodiesel is a fuel comprised of mono-alkyl esters of long chain fatty acids derived from triglycerides. A “mono-alkyl ester” is the product of the reaction of a straight chain alcohol (e.g., methanol or ethanol) with a triglyceride to form glycerine (also known as glycerin or glycerol) and the esters of long chain fatty acids. The triglycerides are commonly obtained from vegetable oils and animal fats of various origins. Biodiesel has a general formula R′OOCR, where R′ is a straight chain lower alkyl (e.g., C₁ to C₈) and R is a hydrocarbon chain from C₈ to C₂₄.

One method of making biodiesel involves the reaction of triglycerides with methanol and with a hydroxide salt catalyst according to reaction (1) below.

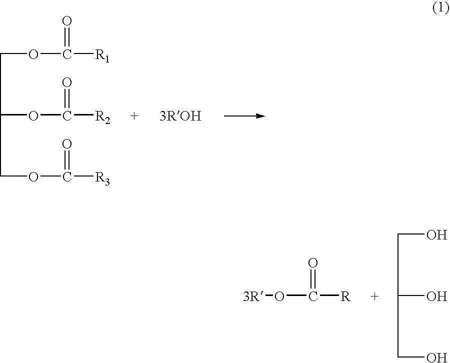

In reaction (1), R represents R₁, R₂, or R₃, which may each be the same or different C₈ to C₂₄ hydrocarbon chain. Additionally, R′ represents an unbranched, straight-chain lower alkyl, such as a methyl or ethyl group.

The process of reaction (1) uses NaOH/KOH as a catalyst for the reaction between triglycerides and alcohol to form a two-phase, soapy, glycerol-based ester with biodiesel. The two-phase mixture is washed with water to separate out the biodiesel. This process can be cumbersome, complex, inefficient, and may elevate the cost of biodiesel.

Biodiesel may also be manufactured by reacting triglycerides with an alkali alkoxide (also known as an alakli alcoholate), such as alkali methoxide or alkali ethoxide, according to reaction (2) below.

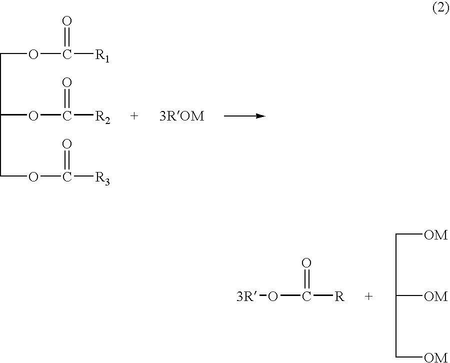

In reaction (2), R represents R₁, R₂, or R₃, each of which may be the same or different C₈ to C₂₄ hydrocarbon chain. Moreover, R′ also represents an unbranched, straight chain lower alkyl, such as a methyl or ethyl group. M represents an alkali metal.

While the alkali alkoxide may be made in a variety of manners, FIG. 1 shows a representative embodiment of an electrolytic cell 100 for preparing alkali alkoxides. As shown, the cell 100 uses an electrochemical reaction to form alkali alkoxides starting from a saline, aqueous catolyte and an alcoholic anolyte. The catholyte is stored in a cathode compartment 102, and the anolyte is stored in an anode compartment 104. The cathode and anode compartments 102, 104 are separated by an ion selective membrane 106 that conducts only ions and is anolyte and catholyte-stable. The cell 100 also includes a cathode 108 and an anode 110. The alkali alkoxide is formed when electricity causes an alkali ion to pass from the aqueous cathode compartment 102 to the anode compartment 104 containing an alcohol through the ion selective membrane 106. This alkali alkoxide may then be mixed with a triglyceride to form biodiesel and an alkali salt of glycerine, which must be purified to form pure glycerine. (For a more detailed explanation of the synthesis of alkali alcoholates, see Ashok V. Joshi et al., Electolytic Method to Make Alkali Alcoholates, U.S. Patent Application Pub. No. 2008/0173551, filed Sep. 28, 2007).

Some industrial processes of manufacturing alkali alkoxides require a metallic alkali metal, such as sodium, or a mercury amalgam. Accordingly, such processes often have significant safety issues and/or often result in a product that is contaminated by mercury. Furthermore, some industrial processes for creating biodiesel and glycerine by reacting alkali alkoxides with triglycerides may require multiple reaction vessels and may require complex, expensive, or time consuming processes to remove alkali ions from the alkali salt of glycerine to form pure glycerine.

Thus, it would be an improvement in the art to provide improved apparatus and methods for the synthesis of biodiesel in a manner that addresses these and other considerations in order to provide potentially more economical production pathways. It would be an improvement in the art to produce biodiesel in a single reaction chamber. Additionally, it would be an improvement to produce biodiesel in a manner that simplifies the removal of alkali ions from the glycerine so as to produce substantially pure biodiesel and gylcerine. Such apparatus and methods are provided herein.

### BRIEF SUMMARY OF THE INVENTION

The present application discusses apparatus and methods for synthesizing biodiesel by using an alkali ion donating material that acts as a catalyst. Generally, these apparatus and methods involve forming a mixture of triglycerides and alcohol in a container, contacting the mixture with an alkali ion donating material, treating the contents of the container with a biodiesel reaction driving force, and then removing the driving force from the container's contents.

Without being bound by theory, as the biodiesel reaction driving force is applied to the alkali ion donating material and the mixture, the alkali ion donating material releases alkali ions. These alkali ions react with the alcohol to form an alkali alcoholate, as shown in reaction (3) below.

R′OH+M⁺R′M+H⁺ (3)

Where R′ and M are defined above in relation to reaction (2).

As part of this reaction, the hydrogen atoms are released from the alcohol as protons, which are received by the alkali ion donating material. As the alkali alcoholates are formed in this process, they react with triglycerides in the mixture to form biodiesel and an alkali salt of glycerine.

The alkali ions may be removed from the alkali salt of glycerine to form a substantially pure form of glycerine in any suitable manner. In some cases, where the alkali ion donating material comprises a catalyst with a high affinity for alkali ions, the catalyst receives alkali ions associated with the alkali salt of glycerine and releases protons. In this manner, alkali ions are removed (or their removal rate is increased) from glycerin by the alkali ion donating catalyst material. For example, when the biodiesel reaction driving force is reduced or removed, the protons, which were received by the ion donating material while the driving force was applied, may be exchanged for the alkali ions of the alkali salt of glycerine. Once the biodiesel and glycerine have been produced, they may be separated from each other in any suitable manner, including through the use of a settling tank. Accordingly, the described methods may produce substantially pure biodiesel and glycerine, without permanently depleting the alkali ion donating material of alkali ions. Moreover, this process may further be completed through the use of an apparatus with a single reaction vessel or container.

The described apparatus for producing biodiesel may comprise any suitable component. For example, the apparatus may comprise a container having a chamber for housing the triglycerides and alcohol, the alkali ion donating material, and a mechanism for applying the biodiesel reaction driving force to some or all of the container's contents.

The container may comprise any component or characteristic that is suitable for the production of biodiesel and glycerine through the described methods. By way of example, the container may have a single, undivided chamber in which the alcohol, triglycerides, and alkali ion donating material can be placed.

The alkali ion donating material can comprise any suitable number of a variety of materials that will release alkali ions (e.g., litium, potassium, and/or sodium) when the biodiesel reaction driving force is applied to it. For instance, the alkali ion donating material may be a catalyst and/or a material in which the alkali ion content is at least partially and permanently consumed during the synthesis of biodiesel. Some non-limiting examples of suitable alkali ion donating catalysts include ceramic ionic conductors (e.g., sodium super ionic conductors or NASICON® conductors), sulfonated tetrafluorethylene copolymers (e.g., NAFION® cationic conductors), stoichiometric, and non-stoichiometric beta alumina (e.g., a conventional sodium beta alumina ceramic material). Some non-limiting examples of an alkali ion donating material that is consumed as it releases alkali ions is sodium carbonate, sodium nitrite, sodium nitrate, sodium bicarbonate, sodium sulfide, and/or other similar compounds.

The alkali ion donating material may have any characteristic that allows it to fulfill its intended purpose. In one example, the alkali ion donating material can be substantially insoluble in alcohol, impervious to water, uninfluenced by scaling or precipitation, and/or have other desired characteristics. In another example, the alkali ion donating material may also have any suitable physical form, including a spherical, granular, cylindrical, powder, or other suitable form.

The biodiesel driving force may be applied to the contents of the container by any mechanism that can produce a thermodynamic force causing the alkali ion donating material to release alkali ions without undesireably effecting the synthesis of biodiesel. Some non-limiting examples of suitable driving force mechanisms may include one or more mechanisms capable of treating the content(s) of the container with an electrical potential, heat, pressure, and/or another form of energy capable of causing the alkali ion donating material to release alkali ions.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but does not necessarily, refer to the same embodiment, but may refer to every embodiment.

Furthermore, the described features, advantages, and characteristics of the described apparatus and methods may be combined in any suitable manner in one or more embodiments. One skilled in the relevant art will recognize that the apparatus and methods may be practiced without one or more of the specific features or advantages of a particular embodiment. In other instances, additional features and advantages may be recognized in certain embodiments that may not be present in all embodiments.

These features and advantages of the described methods and apparatus will become more fully apparent from the following description and appended claims, or may be learned by the practice of the apparatus and methods as set forth hereinafter.

### BRIEF DESCRIPTION OF THE SEVERAL VIEWS OF THE DRAWINGS

In order that the manner in which the above-recited and other features and advantages of the apparatus and methods for producing biodiesel are obtained will be readily understood, a more particular description of the apparatus and methods briefly described above will be rendered by reference to specific embodiments thereof that are illustrated in the appended drawings. Understanding that these drawings depict only typical embodiments and are not therefore to be considered as limiting in scope, the apparatus and methods for producing biodiesel will be described and explained with additional specificity and detail through the use of the accompanying drawings in which:

FIG. 1 provides a general schematic view of a representative embodiment of a prior art electrolytic apparatus for producing alkali alkoxides;

FIG. 2 provides a schematic view of a representative embodiment of the apparatus for producing biodiesel, wherein the apparatus comprises an alkali ion donating material;

FIG. 3 provides a schematic view of a representative embodiment of the apparatus for producing biodiesel, wherein the apparatus comprises an alkali ion donating material, an anode, and a cathode;

FIG. 4 provides a schematic view of a representative embodiment of the apparatus for producing biodiesel, wherein the apparatus comprises an alkali ion donating catalyst, an alkali ion donating material that is consumed as it releases alkali ions, an anode, and a cathode;

FIG. 5 provides a schematic view of a representative embodiment of an apparatus for producing biodiesel, wherein the apparatus comprises a plurality of alkali ion donating materials, anodes, and cathodes;

FIG. 6 provides a flow chart illustrating a representative embodiment of a method for producing biodiesel; and

FIG. 7 provides a flow chart illustrating a representative embodiment of a method for producing biodiesel.

### DETAILED DESCRIPTION OF THE INVENTION

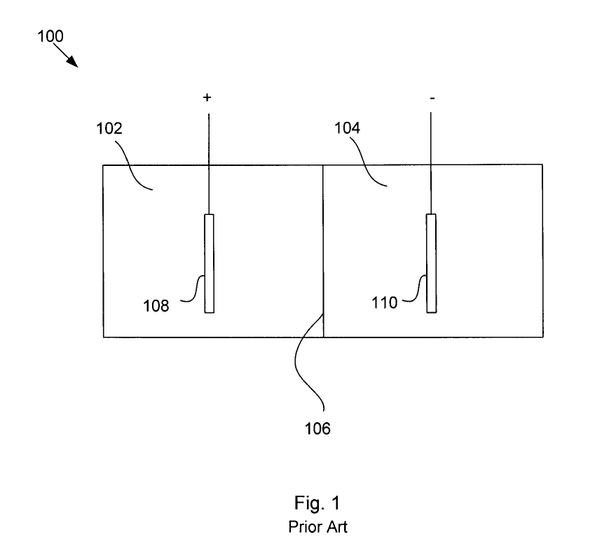

The presently preferred embodiments will be best understood by reference to the Figures, wherein like parts may be designated by like numerals throughout. It will be readily understood that the components of the present invention, as generally described and illustrated in the Figures herein, could be arranged and designed in a wide variety of different configurations. Thus, the following more detailed description of the embodiments of the apparatus and methods of the described apparatus and methods, as represented in FIGS. 1 through 7, is not intended to be limiting in scope, but is merely representative of some presently preferred embodiments.

Various apparatus and methods for producing substantially pure biodiesel and glycerine are described herein. Generally, the methods involve placing one or more alcohols and triglycerides into an apparatus for producing biodiesel, wherein the apparatus comprises an alkali ion donating material or an alkali ion donator. A biodiesel reaction driving force (e.g., an electric potential, heat, pressure, etc.), or a driving force, is applied to the contents of the apparatus. Under a non-binding theory, this driving force causes the alkali ion donator to, at least temporarily, release alkali ions into the contents of the apparatus. In turn, these alkali ions may react with the alcohol in a manner that causes the alkali ion to be substituted for the hydrogen atom in the alcohol's hydroxyl group(s). In other words, the alkali ion reacts with the alcohol to produce an alkali alcoholate and to release protons into the contents of the apparatus.

Such a chemical reaction is shown below:

12R′OH+12M⁺12R′OM+12H⁺

In this chemical reaction, R′ represents an unbranched, straight chain lower alkyl (e.g., C₁ to C₉);
M represents an alkali atom; and R′OM represents an alkali alcoholate.

Under this theory, the protons (H⁺) in the mixture are substantially received by the alkali ion donating material. Moreover, the alkali alcoholates react with triglycerides in the apparatus to produce biodiesel and an alkali salt of glycerine, as shown below:

12R′OM+4[C₃H₅O₃][OCR]₃ 12R′OOCR+4C₃H₅(OM)₃

In this chemical reaction, [C₃H₅O₃][OCR]₃ represents a triglyceride in which R represents the same or different hydrocarbon chain selected from C₈ to C₂₄. Additionally, in this reaction, R′OOCR represents biodiesel and C₃H₅(OM)₃ represents the alkali salt of glycerine.

The production of biodiesel and alkali salts of glycerine can continue until a limiting reactant is consumed, dynamic equilibrium is achieved, or the driving force is reduced or stopped from applying energy to the apparatus's contents. At that point, the alkali ions of the alkali salt of glycerine can be removed and replaced with hydrogen to form pure glycerine or substantially pure glycerine. For instance, in embodiments where the alkali ion donator comprises a catalyst with a high affinity for alkali ions, the reduction or removal of the driving force may allow the alkali ions (M⁺) in the alkali salts of glycerine to be exchanged with the protons (H⁺) that were received by the alkali ion donator during the application of the driving force. In such embodiments, the final mixture in the apparatus comprises substantially pure biodiesel (R′OOCR) and substantially pure glycerine (C₃H₅(OH)₃).

The overall chemical reaction that occurs when the alkali ion donator acts as a catalyst may be summarized as follows:

12R′OH+4[C₃H₅O₃][OCR]₃ 12R′OOCR+4C₃H₅(OH)₃

Once the substantially pure biodiesel and glycerine have been synthesized, the two may be separated through the use of any known or novel technique. For instance, the two may be allowed to settle so that the lighter biodiesel may separate by gravity from the heavier glycerine phase.

To provide a better understanding of the described apparatus and methods for synthesizing biodiesel using an alkali ion donating catalyst, a description of the triglycerides, alcohol, and the apparatus for producing biodiesel in the described manner is given below.

Generally, triglycerides added to the apparatus may comprise any form of triglyceride that can be transesterified to form biodiesel alkyl esters. As used herein, the term transesterified or transesterification may refer to the exchanging of an alkoxyl group of an ester compound for a different alcohol group. Some non-limiting examples of suitable sources of triglycerides may include animal fats (e.g., from beef and sheep tallow, poultry oil, fish oil, etc.), vegetable oil (e.g., from rapeseed, soybeans, Jatropha, mustard, flax, sunflower, palm, hemp, etc.), or other sources of fatty acids (e.g., algae). Although, in some embodiments, only a single form of triglyceride is added to the apparatus during the production of biodiesel, in other embodiments, multiple forms of triglycerides may be used at any suitable concentration.

The alcohol added to the apparatus may comprise virtually any alcohol that can be reacted with an alkali ion to form an alkali alcoholate that is capable of being reacted with a triglyceride to synthesize biodiesel. Generally, however, the alcohol is a straight chain, lower alkyl alcohol, C₁ to C₈, that may be substituted or unsubstituted. Additionally, the alcohol may contain more than one hydroxyl moiety. Examples of typical alcohols that may be used include, but are not limited to, methanol, ethanol, propanol, isopropanol, butanol, hexanol, ethylene glycol, and propylene glycol. Indeed, in some embodiments, the preferred alcohol comprises methanol or ethanol. Nevertheless, in other embodiments, such as where increased cold flow capability of the biodiesel is desired, somewhat higher alcohols, such as isopropanol or butanol may be preferred. Additionally, while the use of a single alcohol may be preferred in some embodiments, the skilled artisan will recognize that more than one alcohol may be used at the same time, at any suitable concentration, in the described apparatus and methods for producing biodiesel.

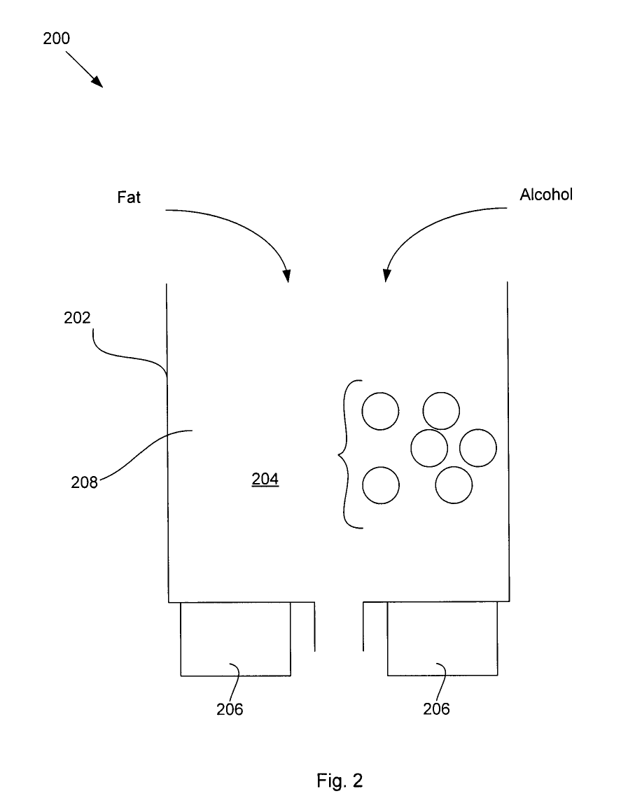

The apparatus for producing biodiesel may comprise any component or characteristic that allows biodiesel and glycerine to be formed therein, in the described manner. By way of example, FIG. 2 shows an embodiment where the apparatus for producing biodiesel 200 comprises a container 202, an alkali ion donator 204, and a mechanism for applying the biodiesel reaction driving force 206. To provide a better understanding of the apparatus, each of the aforementioned components is described below in more detail.

The container may comprise any characteristic that allows it to fulfill its intended house chemicals suitable for the production of biodiesel according to the described methods. For instance, FIG. 2 shows the container 202 comprises a chamber 208. Unlike some prior art devices that necessarily comprise multiple chambers for separating various reactants, FIG. 2 shows that, in at least some embodiments, the container 202 comprises a single chamber 208 in which any or all of the reactants, byproducts, and/or products of the described methods may be mixed. Indeed, the chamber may function as intended while housing the alcohol, triglycerides, and/or alkali ion donating material as well as any intermediates, byproducts, and/or products of the described methods for synthesizing biodiesel.

The container can be made of any suitable material, including metal, glass, plastic, composite, ceramic, other material, or combinations of the foregoing. Additionally, in some embodiments, the materials that form any part of the container are not reactive with or substantially degraded by exposure to the process of producing biodiesel.

The alkali ion donator may comprise one or more of a variety of materials that are capable of at least temporarily donating an alkali ion to react with the alcohol to form an alkali alcoholate that can cause the transesterification of a triglyceride. As used herein, the term alkali ion may refer to the cationic ion of any alkali metal (e.g., sodium, lithium, and potassium) that can react with an alcohol to form an alkali alchoholate. Some examples of suitable alkali ion donators include alkali ion donating catalysts and alkali ion donators in which the content of alkali ions are at least partially and permanently consumed during the production of biodiesel. Additionally, because the alkali ion donator is used in the presence of alcohol, in some preferred embodiments, the alkali ion donator is substantially insoluble in alcohol.

Where the alkali ion donator comprises an alkali ion donating catalyst, the catalyst may comprise any suitable material that can act as a catalyst in the described methods. Said differently, the alkali ion donating catalyst may comprise virtually any material that is capable of releasing alkali ions under a driving force and then, through the material's high alkali ion affinity, receiving the ions so as to prevent them from attaching or staying attached to a byproduct of the biodiesel reaction when the driving force is removed. Examples of suitable alkali ion donating catalysts comprises an alkali intercalation material, such as NaFePO₄, LiFePO₄, Na intercalated into carbon, and Li intercalated into carbon. Another example of a suitable type of alkali ion donating catalyst comprises alkali ion conductors. Some non-limiting examples of such may comprise sodium super ionic conductors (e.g., NaSICON conductors produced by Ceramatec, Inc. of Salt Lake City, Utah), sulfonated tetrafluorethylene copolymers (e.g., NAFION® cationic conductors produced by DuPont Fluoroproducts, Inc. of Fayetteville, N.C.), or other stoichiometric and nonstoichiometric beta alumina materials that have suitable alkali ion donating properties.

In some embodiments, ceramic ionic conductors may be the preferred alkali ion donator. Indeed, such materials may have several characteristics that make them especially well suited for use in the described apparatus. For example, as previously mentioned, NaSICON and NAFION® may have good ion-donating characteristics under the application of biodiesel reaction driving force, even at low temperatures. Similarly, such conductors may have a high affinity and selectivity for alkali ions when the driving force is removed or reduced. Thus, such materials may donate alkali ions to form alkali alcoholates and then remove or prevent alkali ions from bonding to byproducts of the biodiesel reaction so as to form substantially pure biodiesel and glycerine. Moreover, due to the alkali ion donator's high affinity, the alkali ion donator may be used in multiple reactions and retain a substantially equal alkali ion load from reaction to reaction. Additionally, ceramic ionic conductors, such as NAFION® conductors, may be loaded with alkali ions (e.g., Na⁺) before use as the alkali ion donating material. Ceramic ionic conductors may also be dense, substantially impervious to water transport, and be substantially uninfluenced by scaling or precipitation of divalent ions, trivalent ions, tetravalent ions, or dissolved solids present in apparatus. Other examples of advantageous characteristics are that some ceramic ionic conductors do not degrade in the presence of corrosive elements and may function as intended over a wide pH range (e.g., about 2 to about 14).

Where the ceramic ionic conductor comprises a NaSICON conductor, any NaSICON conductor capable of acting as an alkali ion donating catalyst, as described herein, may be used. NaSICON-type ionic conductors are known in the art. A non-limiting disclosure of such materials is provided by H. Y-P. Hong, “Crystal Structure and Crystal Chemistry in the System Na₁₊ₓZr₂SiₓP₃₋ₓO₁₂, Mat. Res. Bull., Vol. 11, pp. 173-182, 1976. For instance, some preferred stiochiometric and non-stiochiometric NaSICON type materials may include those having the formula M¹M²A(BO₄)₃ where M¹ and M² may be independently chosen from Li, Na, and K, and where A and B include metals and main group elements. For additional information regarding NaSICON conductors (also known as membranes), see Shekar Balagopal et al., Synthesis of Biodiesel Using Alkali Ion Conductive Ceramic Membranes, U.S. Patent Application No. 2007/0158205, filed Jan. 11, 2007, the entire disclosure of which is herein incorporated by reference. While the foregoing discussion relates to NaSICON-type materials, it will be appreciated that other alkali super ion conducting materials which transport lithium and potassium ions, are known and may be utilized in place of sodium super ion conducting materials.

As previously mentioned, the alkali ion donator may comprise a material that is partially consumed, or in which its content of alkali ions is permanently reduced, as part of the biodiesel reaction. Such a material may comprise a variety of materials that are capable of donating alkali ions when the biodiesel reaction driving force is applied to it. Some non-limiting examples of such an alkali ion donator is sodium carbonate, sodium nitrite, sodium nitrate, sodium bicarbonate, sodium sulfide, and/or other similar compounds.

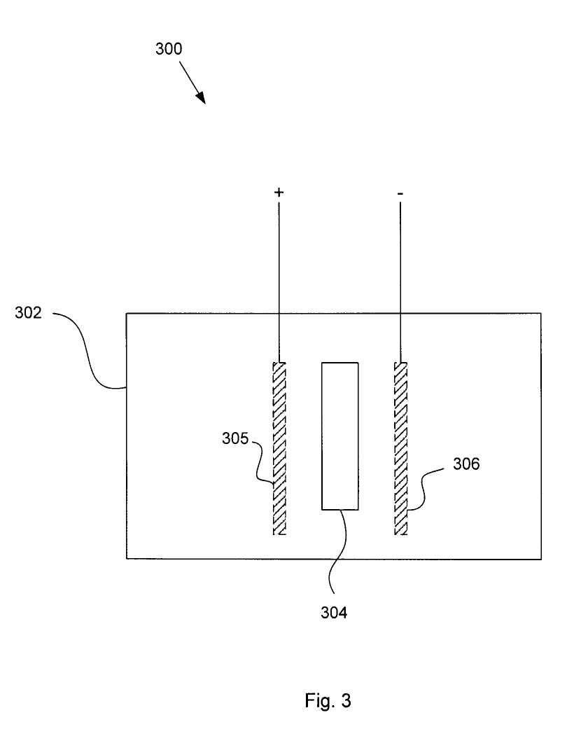

No matter the type of alkali ion donator used in the described apparatus and methods, the alkali ion donator may be in any suitable physical form, including a granular, spherical, block, plate, sheet, powder, chunk, bead, filament, or other desired form. For example, FIG. 2 shows some embodiments where a bead form of the alkali ion donator 204 is placed in the container 202. In contrast, FIG. 3 shows some embodiments in which a plate form of the alkali ion donator 304 is placed in the container 302.

The biodiesel reaction driving force may be any suitable force that, when applied to the alkali ion donator, causes the donator to release alkali ions and that, when removed from the donator, does not force the donator to release additional alkali ions. By way of example, the driving force may include heat, pressure, electric potential, another suitable form of energy, or combinations thereof. Accordingly, the mechanism for applying the biodiesel reaction driving force, or the driving mechanism, may be any mechanism that is suitable for use with the described apparatus and capable of producing a suitable level of one or more of the described biodiesel reaction driving forces.

According to some embodiments, the driving mechanism 206 in FIG. 2 comprises a heater. Such a heater may comprise any mechanism that is capable of raising the temperature of one or more of the contents of the apparatus 200 enough to cause the alkali ion donator 204 to release alkali ions. For instance, such a heater may raise the temperature of one or more components of the container to a temperature selected from between about 100° C. and about 800° C., about 200° C. and about 600° C., and about 100° C. and about 500° C. Some examples of suitable heaters may comprise a conventional heater (e.g., a heat coil, a flame, an infrared radiant heat burner, etc.) or a mechanism capable of providing microwave energy to the contents of the apparatus.

Although FIG. 2 depicts an open container 202, it will be understood that in other embodiments, the container 202 is sealable and capable of being pressurized. In one example, the container comprises a lid or hatch that is capable of retaining pressure inside the container. In another example, the apparatus also comprises a pump/compressor that can increase the container's interior pressure. Indeed, the apparatus may comprise any mechanism suitable to pressurize the alkali ion donator enough to cause the donator to release alkali ions. Indeed, in some embodiments, the driving mechanism is capable of pressurizing one or more contents of the container to a pressure selected from about 1 bar to about 50 bar, about 2 and about 20, and about 5 and about 10.

Where the driving mechanism produces an electric potential, the electric potential may be applied to one or more contents of the container (e.g., the alkali ion donating material) in any suitable manner. By way of illustration, FIG. 3 illustrates some embodiments of the apparatus 300 in which an electrical potential is applied to one or more contents of the container 302 through the use of a cathode 305 and an anode 306. In such embodiments, electric potential from the electrodes (305 and 306) drives alkali ions from the alkali ion donating material 304 (e.g., a NaSICON or NAFION® conductor). As in the case of the other biodiesel reaction driving forces, when the electric potential is removed from the container's contents, the biodiesel driving force no longer causes alkali ions to be released from the alkali ion donating material. Moreover, if the alkali ion donating material comprises an alkali ion donating catalyst, the alkali ions (e.g., Na⁺) may be allowed to return to the host lattice.

In embodiments where the apparatus comprises a cathode and anode (e.g., 305 and 306, respectively), the electrodes comprise suitable electrical conductors and are preferably stable in the media to which they are exposed. Indeed, in such embodiments, the electrodes may comprise any suitable material, and the material may be solid, plated, perforated, expanded, or otherwise adapted for a desired use. By way of non-limiting example, some suitable materials for the formation of the anode may comprise stainless steel, lead, graphite, tungsten carbide, titanium diboride, nickel, cobalt, nickel tungstate, nickel titanate, platinum, and/or a noble anode metal, as a solid plated on a substrate, such as platinum-plated titanium. In one example, the anode comprises a dimensionally stable anode (DSA), which is comprised of ruthenium oxide coated titanium. Similarly, some non-limiting examples of suitable cathode materials may include metals (e.g., nickel, cobalt, platinum, silver, and the like) and alloys (e.g., titanium carbide) with small amounts of nickel, FeAl₃, NiAl₃, stainless steel, perovskite ceramics, and/or other suitable materials. Of course, the skilled artisan will recognize that, in some instances, by balancing electrical efficiency with the low cost of specific electrode materials, the materials used to form the electrodes can be chosen to maximize cost efficiency effectiveness.

In addition to the previously mentioned electrode materials, in some embodiments, one or more of the electrodes comprises at least one suitable alkali ion donator. Indeed, in some preferred embodiments, one or more of the electrodes comprise an alkali ion donating catalyst, such as a NaSICON or NAFION® conductor. Where an electrode comprises an alkali ion donator, the donator may be incorporated in the electrode in any suitable way. For instance, the alkali ion donating material may be mixed into the materials forming the electrode, contained in the electrode, coated on the electrode, and/or otherwise be associated with the electrode.

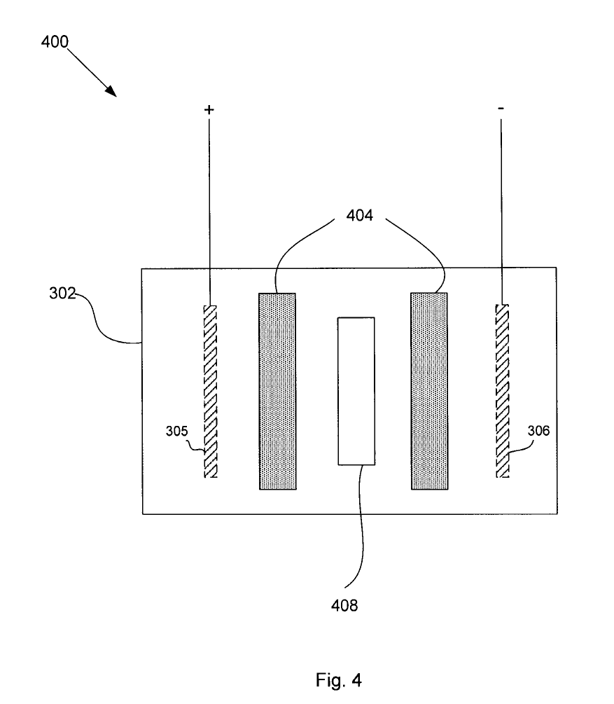

In addition to the previously described components and characteristics, the apparatus may be modified in any suitable manner. For instance, the apparatus may comprise more than one alkali ion donator. The presence of multiple alkali ion donators may be beneficial because it can increase the reaction rate and efficiency as well as increase the amount of reactants that may be treated in the apparatus. By way of illustration, FIG. 4 shows some embodiments where the apparatus 400 includes multiple alkali ion donators. Although the apparatus may comprise any suitable number of alkali ion donators, FIG. 4 shows a representative embodiment in which the apparatus 400 comprises 3 alkali ion donators 404 and 408.

Where the apparatus comprise more than one alkali ion donator, each donator may comprise the same or different type of alkali ion donating material. For instance, the apparatus may comprise multiple donators that are formed from the same type of alkali ion donator (e.g., multiple pieces of NAFION® conductor). In contrast, FIG. 4 illustrates some embodiments where the apparatus 400 comprises different types of alkali ion donating materials 404 and 408. In such embodiments, the apparatus may comprise any suitable combination of alkali ion donating materials. In one example, the first alkali ion donator 404 comprises a first alkali ion donating catalyst 404 (e.g., a NaSICON conductor) and the second alkali ion donator 408 comprises a second alkali ion donating catalyst (e.g., a NAFION® conductor). In a second example, however, the first alkali ion donator 404 comprises an alkali ion donating catalyst (e.g., a NaSICON conductor) and the second alkali ion donator 408 comprises a material that is consumed during the synthesis of biodiesel (e.g., sodium carbonate). As a side note, in this second example, when a biodiesel reaction driving force is applied to sodium carbonate, a sodium ion (Na⁺) may be released to react with an alcohol to form a sodium alcoholate. As the sodium ion is released, carbon dioxide may be evolved and captured. Once the driving force is reduced or removed, the sodium ions donated by the sodium carbonate (e.g., alkali ion donator 408) may be received or captured by the alkali ion donating catalyst 404. In this manner, the sodium ions may act to remove alkali ions from the alkali salt of glyceine or the alkali ions may be prevented from “dirtying” the resulting glycerine.

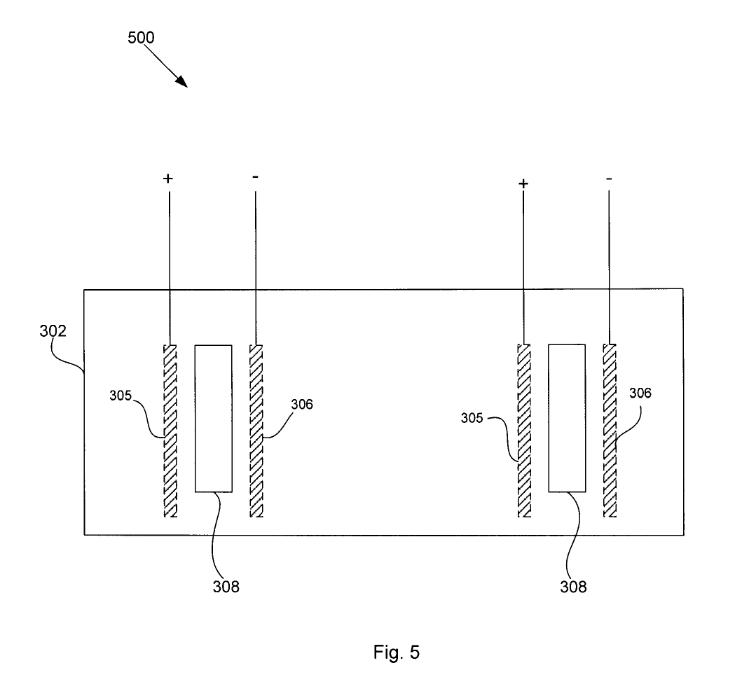

In some embodiments, the apparatus comprises more than one driving mechanism. In such embodiments, the apparatus may comprise any suitable number of driving mechanisms. Multiple driving mechanisms may allow the apparatus to increase the rate and efficiency of the biodiesel reaction. Similarly, multiple driving mechanism may allow the apparatus to treat a larger amount of reactants than may a single driving force. Where the apparatus comprises more than one driving mechanism, or driving mechanism that produces more than one driving force, the apparatus may comprise any suitable combination of different types of driving mechanisms. In one non-limiting example, the apparatus comprises a first driving mechanism that acts to heat the contents of the container and a second driving mechanism that pressurizes the contents of the container. In another example, the apparatus comprises a driving mechanism that heats, pressurizes, and applies an electrical potential to the contents of the container. In still another example, FIG. 5 shows some embodiments where the apparatus 500 comprises a plurality of the same type of driving mechanism, namely a plurality of cathodes 305 and anodes 306. In so doing, FIG. 5 shows that where the apparatus 500 comprises more than a single driving mechanism, the driving mechanisms (e.g., cathodes 305 and anodes 306) may each, though not necessarily, be used with a separate alkali ion donator (e.g., alkali ion donator 308).

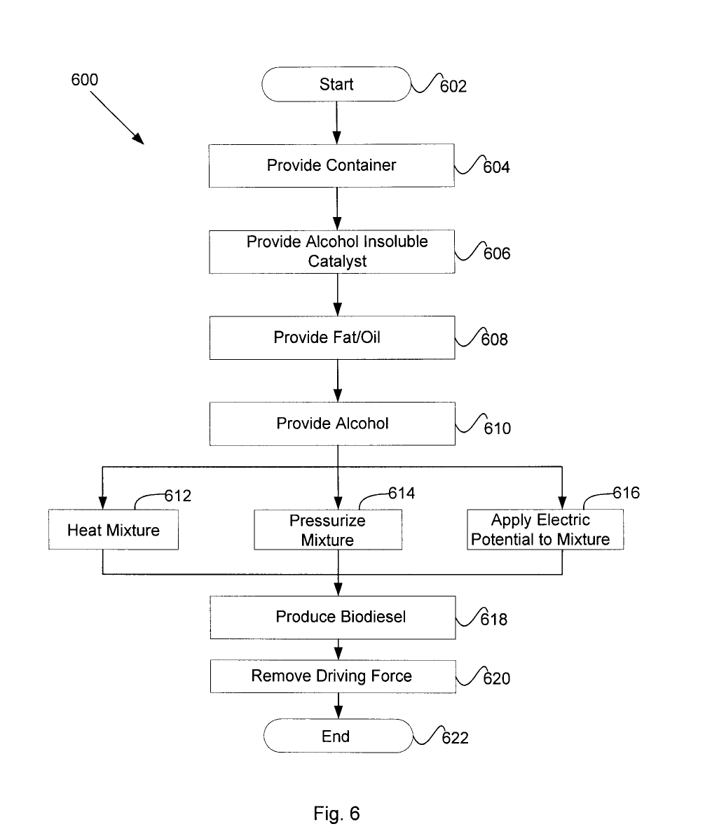

The described apparatus may be used in any suitable method. By way of non-limiting example, FIG. 6 shows some embodiments of a typical method 600 for producing biodiesel using an alkali ion donating catalyst. Specifically, after beginning at 602, the method continues at 604 by providing a container for housing an alcohol and a triglyceride. Next, at 606, the method continues by placing an alcohol insoluble alkali donating catalyst in the container. This catalyst is then contacted with a tricylceride and an alcohol, as shown at 608 and 610. At this point, a biodiesel reaction driving force (e.g., the heat shown at 612, the pressure shown at 614, and/or the electrical potential shown at 616) may be applied to the mixture of triglyceride and alcohol. As previously stated, this driving force may cause the formation of biodiesel and an alkali salt of glycerine. Once the driving force is removed at 620, the apparatus may contain substantially pure biodiesel and substantially pure glycerine. The method may then be ended at 622.

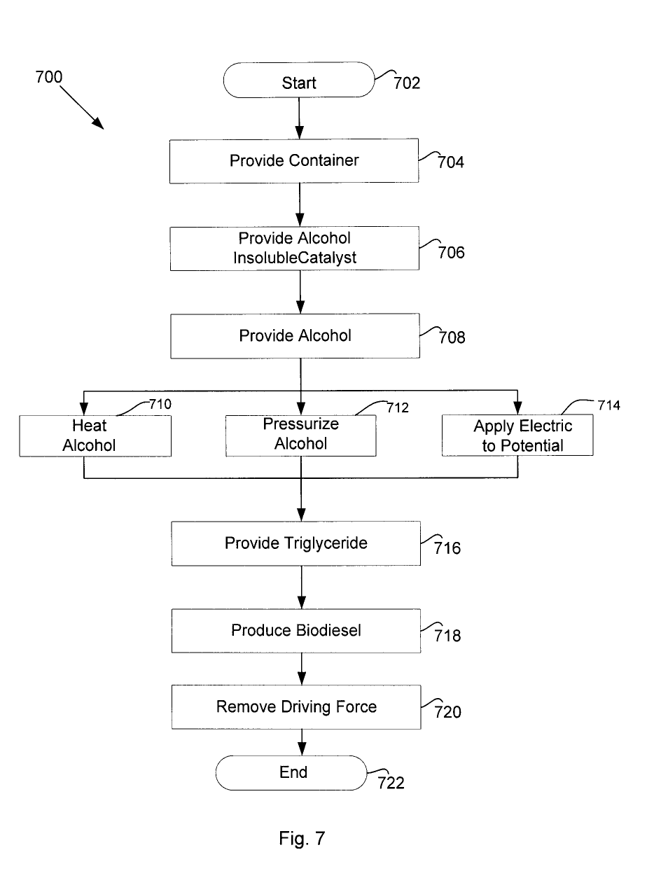

Of course, the described methods may involve other steps and methods that are equivalent in function or effect to one or more portions of the method illustrated in FIG. 6. Moreover, the order in which a particular method occurs may be changed in any suitable manner. By way of example, FIG. 7 illustrates other embodiments of the described method for producing biodiesel in which the biodiesel driving force is applied before the triglyceride is placed in the container. In particular, the method of FIG. 7 shows that after the method 700 begins at 702, it may continue by providing a container (shown at 704), placing an alcohol insoluble alkali ion donating catalyst in the container (shown at 706), and placing an alcohol in the container with the catatlyst (shown at 708). At this point, the biodiesel reaction driving force (e.g., heat in box 710, the pressure in box 712, or the electrical potential in box 714) may be applied to the alcohol and catalysts to form an alkali alcoholate. After the application of the driving force, or while it is still being applied, 716 shows the triglyceride may be added to the container to react with the alkali alcoholates and form biodiesel, shown at 718. If it has not already been removed, the biodiesel reaction driving force may be removed at 720 to form a composition comprising substantially pure biodiesel and glycerine. The method may then be ended at 722.

In some embodiments of the described methods and apparatus, the apparatus may be operated in a continuous mode. In a continuous mode, the apparatus may be operated in any suitable manner. For example, the container may initially be filled with an alcohol, a triclyceride, and an alkali ion donator. Then, during operation, additional reagents may be fed into the container and products, by-products, and/or diluted solutions may be removed from the container without ceasing operation of the cell. The feeding of the reagents into the container may be done continuously or it may be done intermittently, meaning that the flow of a given reactant is initiated or stopped according to the need for the reactant and/or to maintain desired concentrations of reactants in the container, without emptying the container. Similarly, the removal of compositions from the container may also be continuous or intermittent.

Control of the addition and/or removal of chemicals from the container may be done by any suitable means. Such means may include manual operation, such as by one or more human operators, and automated operation, such as by using sensors, electronic valves, laboratory robots, etc. operating under computer or analog control. In automated operation, a valve or stopcock may be opened or closed according to a signal received from a computer or electronic controller on the basis of a timer, the output of a sensor, or other means. Examples of automated apparatus are well known in the art. Some combination of manual and automated operation may also be used. Alternatively, the amount of each chemical that is to be added or removed per unit of time to maintain a steady state may be experimentally determined for a given apparatus, and the flow of chemicals into and out of the apparatus may be set accordingly to achieve the steady state flow conditions.

In another embodiment, the apparatus is operated in batch mode. In batch mode, the reagents are fed into the container and the container is operated until the desired concentration of product is produced. The container is then emptied, the product collected, and the container refilled to start the process again. Alternatively, combinations of continuous mode and batch mode production may be used. Also, in either mode, the feeding of chemicals (e.g., triglycerides and alcohols) may be done using a pre-prepared solution or using components that form the desired mixture in situ.

As mentioned throughout, the described apparatus and methods may offer several advantages and benefits over some conventional apparatus and methods for producing biodiesel. By way of example, the described methods and apparatus may include a single chamber in which both the alkali alcoholate, the biodiesel and, the glycerine are produced. According, the described apparatus and methods may be simple and relatively inexpensive. Additionally, because the apparatus may include an alkali ion donating catalyst, the apparatus may efficiently and effectively produce pure glycerine, while allowing the catalyst maintain a substantially constant alkali ion concentration between multiple biodiesel reactions.

While specific embodiments of the present invention have been illustrated and described, numerous modifications come to mind without significantly departing from the spirit of the invention, and the scope of protection is only limited by the scope of the accompanying claims.

1. An apparatus for producing biodiesel, the apparatus comprising:
a container having a chamber for housing a mixture that comprises a triglyceride and an alcohol;
a material that is substantially insoluble in the alcohol and capable of donating an alkali ion; and
a biodiesel reaction driving force mechanism that is capable of causing the alcohol insoluble material to donate the alkali ion.

2. The apparatus of claim 1, wherein the biodiesel reaction driving force mechanism is selected from a heater to heat the mixture, a pump to pressurize the mixture, and a cathode and anode to apply an electric potential to the mixture.

3. The apparatus of claim 1, wherein the anode and the cathode are both disposed in the same chamber.

4. The apparatus of claim 1, wherein the alcohol insoluble material comprises an alkali ion donating catalyst that has an affinity for the alkali ion such that the alcohol insoluble material removes alkali ions from alkali salts of glycerine to form substantially pure glycerine.

5. The apparatus of claim 3, wherein the alkali ion donating catalyst comprises an alkali super ion conductor.

6. The apparatus of claim 3, wherein the alkali donating catalyst is selected from a sodium beta alumina, an ion selective membrane, an alkali intercalation material, and a sodium super ionic conductor type material having the formula M¹M²A(BO₄)₃, wherein M¹ and M² are independently selected from Li, Na, and K, and wherein A and B are selected from a metal and main group elements.

7. The apparatus of claim 1, wherein a portion of an alkali ion content of the alcohol insoluble material is permanently consumed while producing the biodiesel.

8. The apparatus of claim 7, wherein the alcohol insoluble material comprises sodium carbonate.

9. A method for producing biodiesel, the method comprising;
providing a container;
placing an alcohol in the container;
placing triglycerides in the container;
providing the container with a material that is substantially insoluble in alcohol and capable of donating an alkali ion;
causing the alcohol insoluble material to donate the alkali ion so that the alkali ion reacts with the alcohol to form an alkali alcoholate; and
allowing the alkali alcoholate to react with the triglyceride to form a composition comprising biodiesel.

10. The method of claim 9, wherein the alcohol insoluble material is caused to donate the alkali ion through a treatment selected from heating the alcohol insoluble material, pressurizing the alcohol insoluble material, and applying an electrical potential to the alcohol insoluble material.

11. The method of claim 10, wherein the composition is heated to a temperature within a temperature range selected from about 100° C. and about 800° C., from about 200° C. and about 600° C., and from about 100° C. and about 500° C.

12. The method of claim 10, wherein the composition is pressurized to a pressure within a pressure range selected from about 1 bar to about 50 bar, from about 2 and about 20, and from about 5 and about 10.

13. The method of claim 9, wherein the alcohol insoluble material comprises an alkali donating catalyst.

14. The method of claim 12, further comprising allowing the alkali donating catalyst to remove alkali ions from alkali salts of glycerine to form substantially pure biodiesel and substantially pure glycerine.

15. The method of claim 12, wherein the alkali donating catalyst comprises an alkali super ion conductor.

16. The method of claim 9, wherein an alkali ion content of the alcohol insoluble material is permanently consumed as it donates the alkali ion.

17. A composition that forms biodiesel, the composition comprising:
a mixture comprising an alcohol and a triglyceride, wherein the mixture is in contact with a material that is substantially insoluble in alcohol and capable of donating an alkali ion to react with the alcohol to form an alkali alcoholate; and
a biodiesel reaction driving force selected from heating the mixture, pressurizing the mixture, and applying an electrical potential to the mixture.

18. The composition of claim 16, wherein the alcohol insoluble material comprises an alkali donating catalyst that has an affinity for the alkali ion such that the alcohol insoluble material removes alkali ions from alkali salts of glycerine to form substantially pure glycerine.

19. The composition of claim 16, wherein the alcohol insoluble material comprises both an alkali donating catalyst and an alkali donating material in which an alkali ion content is at least partially consumed as it donates the alkali ion.

20. The composition of claim 16, wherein alcohol insoluble material comprises alkali salts selected from sodium carbonate, sodium nitrite, sodium nitrate, sodium bicarbonate, and sodium sulfide.

21. The composition of claim 16, wherein the alcohol insoluble material comprises an alkali super ion conductor.

22. The composition of claim 16, wherein the alcohol insoluble material is selected from a sodium beta alumina, an ion selective membrane, an alkali intercalation material, and a sodium super ionic conductor type material having the formula M¹M²A(BO₄)₃, wherein M¹ and M² are independently selected from Li, Na, and K, and wherein A and B are selected from a metal and main group elements.

23. The composition of claim 16, wherein the alkali ion is selected from a lithium ion, a sodium ion, and a potassium ion.
